(19) United States
(12) Patent Application Publication
(10) Pub. No.: US 2012/0031668 A1
(43) Pub. Date: Feb. 9, 2012

(54) PRESS-CONTACT CONNECTION APPARATUS AND ILLUMINATION APPARATUS

(75) Inventor: Tetsuro TAKASAKI, Makinohara-shi (JP)

(73) Assignee: YAZAKI CORPORATION, Tokyo (JP)

(21) Appl. No.: 13/181,645

(22) Filed: Jul. 13, 2011

(30) Foreign Application Priority Data
Jul. 14, 2010 (JP) 2010-159366
Jun. 24, 2011 (JP) 2011-140254

(51) Int. Cl. H01R 4/24

(52) U.S. Cl. 174/84 R

(57) ABSTRACT

There is provided a press-contact connection apparatus, including: a base part; press-contact terminals which are fixed to the base part; and an electric wire holder which holds a plurality of electric wires to be press-contacted with the respective press-contact terminals. The base part includes a support which supports the electric wire holder rotatably and serves as a fulcrum of a rotation of the electric wire. The electric wire holder includes a rotational shaft which is provided in one end portion of the electric wire holder and supported by the support. The electric wire holder holds the plurality of electric wires to be extended in an axial direction of the rotational shaft, and bends a part of each electric wire in a U-shape so that a bottom portion of the U-shape is arranged closer to the support than a portion bent and extending from an upper end of the U-shape is.

### BACKGROUND OF THE INVENTION

1. Technical Field

The present invention relates to a press-contact connection apparatus and an illumination apparatus provided with the press-contact connection apparatus.

2. Background Art

In the past, there has been known a press-contact connection apparatus which press-contacts an electric wire within a groove of a press-contact blade of a press-contact terminal when the electric wire is to be connected to the terminal. Here, the “press-contact” means that the electric wire is pressed onto the press-contact terminal, and an insulative coat of the electric wire is cut out with the press-contact blade of the press-contact terminal, thereby causing a core wire which is exposed by the cut-out to be contact with the press-contact terminal. For example, there is proposed an in-door illumination apparatus for vehicle having a function of press-contacting a plurality of electric wires onto respective press-contact terminals in JP2009-280078A.

In the in-door illumination apparatus for vehicle disclosed in JP2009-280078A, a strain-relief structure is adopted which holds the respective electric wires in a flexed manner so as not to act a tensile force directly onto a press-contact part even if the tensile force is applied to the electric wires.

In the in-door illumination apparatus for vehicle disclosed in JP2009-280078A, since a load must be applied to the plurality of electric wires during the press-contact, the load applied during the press-contact may be large.

### SUMMARY OF THE INVENTION

The present invention is achieved in view of the above problems, and aims at providing a press-contact connection apparatus capable of surely maintaining a connection of the electric wires and the press-contact terminals and minimizing the load during the press-contact, and an illumination apparatus provided with the press-contact connection apparatus.

According to an aspect of the invention, there is provided a press-contact connection apparatus, including: a base part; press-contact terminals which are fixed to the base part; and an electric wire holder which holds a plurality of electric wires to be press-contacted with the respective press-contact terminals. The base part includes a support which supports the electric wire holder rotatably and serves as a fulcrum of a rotation of the electric wire. The electric wire holder includes a rotational shaft which is provided in one end portion of the electric wire holder and supported by the support. The electric wire holder holds the plurality of electric wires to be extended in an axial direction of the rotational shaft, and bends a part of each electric wire in a U-shape so that a bottom portion of the U-shape is arranged closer to the support than a portion bent and extending from an upper end of the U-shape is arranged.

According to the aspect of the invention, since the plurality of electric wires are held so that a part of each electric wire is bent in a U-shape, the connection state between the electric wires and the press-contact terminals is surely maintained. Further, since the bottom portion of the U-shape of the electric wire is arranged closer to the support serving as the fulcrum of the rotation of the electric wire holder than the portion bent and extending from the upper end of the U-shape is arranged, the electric wires W can be press-contacted while bringing the electric wires close to the fulcrum. Consequently, it is possible to minimize the load during the press-contact.

### BRIEF DESCRIPTION OF THE DRAWINGS

In the accompanying drawings:

FIG. 1 is an exploded perspective view of an illumination apparatus provided with a press-contact connection apparatus according to a first embodiment of the invention;

FIG. 2 is a perspective view of the illumination apparatus shown in FIG. 1;

FIG. 3 is a perspective view showing a state before an electric wire holder is attached to the illumination apparatus shown in FIG. 1;

FIG. 4 is a plan view in a periphery of the electric wire holder as shown in FIG. 1;

FIG. 5 is a diagram for explaining a press-contact terminal shown in FIG. 1;

FIG. 6 is a perspective view of the electric wire holder shown in FIG. 1;

FIG. 7 is a perspective view showing a state where an engagement of an upper pressing portion and a lower pressing portion of the electric wire holder is released;

FIG. 8 is a side view of the electric wire holder shown in FIG. 1;

FIG. 9 is a cross-sectional view of the electric wire holder taken from line IX-IX shown in FIG. 8;

FIG. 10 is a side view of the electric wire holder for explaining that the electric wires are held so as to be bent in a U-shape;

FIG. 11 is a top view of the electric wire holder for explaining that the electric wires are held so as to be bent in a U-shape;

FIG. 12 is an enlarged view in a periphery of the press-contact terminal as shown in FIG. 3;

FIG. 13 is a cross-sectional view of the illumination apparatus taken from line XIII-XIII as shown in FIG. 4;

FIG. 14 is a diagram for explaining that an adjacent wall shown in FIG. 1 is provided closer to a vicinity of a support than anti-slip wall is;

FIG. 15 is a side view showing the press-contact connection apparatus according to the first embodiment of the invention;

FIG. 16 is a diagram showing a procedure in which the plurality of electric wires are press-contacted onto the press-contact terminals by the press-contact connection apparatus according to the first embodiment of the invention;

FIG. 17 is a diagram showing the procedure in which the plurality of electric wires are press-contacted onto the press-contact terminals by the press-contact connection apparatus according to the first embodiment of the invention;

FIG. 18 is a diagram showing the procedure in which the plurality of electric wires are press-contacted onto the press-contact terminals by the press-contact connection apparatus according to the first embodiment of the invention;

FIG. 19 is a diagram showing the procedure in which the plurality of electric wires are press-contacted onto the press-contact terminals by the press-contact connection apparatus according to the first embodiment of the invention;

FIG. 20 is a diagram showing the procedure in which the plurality of electric wires are press-contacted onto the press-contact terminals by the press-contact connection apparatus according to the first embodiment of the invention;

FIGS. 21A to 21C are diagrams for explaining that the electric wire comes close to a press-contact blade in accordance with rotation of the electric wire holder;

FIG. 22 is a side view showing a press-contact connection apparatus according to a second embodiment of the invention;

FIG. 23 is a perspective view of an electric wire holder shown in FIG. 22;

FIG. 24 is a diagram showing a procedure in which the plurality of electric wires are press-contacted onto the press-contact terminals by the press-contact connection apparatus according to the second embodiment of the invention;

FIG. 25 is a diagram showing the procedure in which the plurality of electric wires are press-contacted onto the press-contact terminals by the press-contact connection apparatus according to the second embodiment of the invention;

FIG. 26 is a diagram showing the procedure in which the plurality of electric wires are press-contacted onto the press-contact terminals by the press-contact connection apparatus according to the second embodiment of the invention;

FIG. 27 is a diagram showing the procedure in which the plurality of electric wires are press-contacted onto the press-contact terminals by the press-contact connection apparatus according to the second embodiment of the invention;

FIG. 28 is a diagram showing the procedure in which the plurality of electric wires are press-contacted onto the press-contact terminals by the press-contact connection apparatus according to the second embodiment of the invention; and

FIGS. 29A and 29B are diagrams for explaining a prevention function of a wrong assembly of the electric wire holder shown in FIG. 22.

### DETAILED DESCRIPTION OF THE EXEMPLARY EMBODIMENTS

A first aspect of the present invention provides a press-contact connection apparatus, including: a base part; press-contact terminals which are fixed to the base part; and an electric wire holder which holds a plurality of electric wires to be press-contacted with the respective press-contact terminals, wherein the base part includes a support which supports the electric wire holder rotatably and serves as a fulcrum of a rotation of the electric wire, the electric wire holder includes a rotational shaft which is provided in one end portion of the electric wire holder and supported by the support of the base part, and the electric wire holder holds the plurality of electric wires to be extended in an axial direction of the rotational shaft, and bends a part of each electric wire in a U-shape so that a bottom portion of the U-shape is arranged closer to the support than a portion bent and extending from an upper end of the U-shape is arranged.

The press-contact connection apparatus may be configured, as a second aspect of the invention, so that the rotational shaft has a semi-circular columnar shape, and the support includes a slit which is open to an upper end of the support and through which the rotational shaft is inserted, the width of the slit being substantially equal to the radius of the rotational shaft.

The press-contact connection apparatus may be configured, as a third aspect of the invention, so that the support further includes an enlarged slit which is formed by enlarging a back of the slit and is continuous from the slit so as to rotate the rotational shaft in the enlarged slit.

The press-contact connection apparatus may be configured, as a fourth aspect of the invention, so that the press-contact terminal includes a press-contact blade, and the press-contact blade is provided with a groove being formed in a shape along a circle around the rotating shaft.

The press-contact connection apparatus may be configured, as a fifth aspect of the invention, so that the base part includes an adjacent wall which is disposed adjacently to the press-contact blade in the thickness direction of the press-contact blade, in which a groove part is formed in correspondence with a shape of the groove of the press-contact blade to enable the press-contact by the press-contact blade, and which is a wall on which the electric wire holder slides when the electric wire holder is rotated.

The press-contact connection apparatus may be configured, as a sixth aspect of the invention, so that the press-contact blade is provided in plural, and the press-contact terminal includes a press-contact blade group in which the press-contact blades are disposed with a clearance in the thickness direction of the press-contact blades.

A seventh aspect of the invention provides an illumination apparatus provided with the press-contact connection apparatus, wherein the illumination apparatus is capable of an illumination function by supplying a power from the plurality of electric wires which are press-contacted with the press-contact terminals of the press-contact connection apparatus.

According to the first aspect of the invention, since the plurality of electric wires are held so that a part of each electric wire is bent in a U-shape, the connection state between the electric wires and the press-contact terminals is surely maintained. Further, since the bottom portion of the U-shape of the electric wire is arranged closer to the support serving as the fulcrum of the rotation of the electric wire holder than the portion bent and extending from the upper end of the U-shape is arranged, the electric wires W can be press-contacted while bringing the electric wires close to the fulcrum. Consequently, it is possible to minimize the load during the press-contact.

According to the second aspect of the invention, the slit, the width of which is substantially equal to the radius of the rotational shaft having a semi-circular columnar shape guides the rotational shaft when the rotational shaft is being attached to the support. Thus, the assembly of the electric wire holder is facilitated.

According to the third aspect of the invention, the enlarged slit is formed in the back of the slit, and the rotational shaft can be rotated in the enlarged slit. Thus, the rotation work of the electric wire holder is facilitated.

According to the fourth aspect of the invention, the groove of the press-contact blade is formed along an insertion direction of the electric wire holder. Thus, the load applied to the press-contact blade during the press-contact, and the deformation of the press-contact terminal can be prevented.

According to the fifth aspect of the invention, the base part includes an adjacent wall which is disposed adjacently to the press-contact blade in the thickness direction of the press-contact blade, in which a groove part is formed in correspondence with a shape of the groove of the press-contact blade to enable the press-contact by the press-contact blade, and which is a wall on which the electric wire holder slides when the electric wire holder is rotated. Thus, it is possible to protect a surface of the press-contact blade 31a, and also prevent the electric wire holder 40 from being slipped in the thickness direction of the press-contact blade 31a.

According to the sixth aspect of the invention, the adjacent wall disposed adjacently to the press-contact blade group is slid on the electric wire holder. That is, the adjacent wall which is disposed with a clearance in the thickness direction of the press-contact blade contacts the electric wire holder. Thus, the prevention of the electric wire holder from being slipped in the thickness direction of the press-contact blade can be more enhanced.

According to the seventh aspect of the invention, since the illumination apparatus is provided with the press-contact connection apparatus, the same advantageous effects can be obtained as the press-contact connection apparatus.

Exemplary embodiments of an illumination apparatus provided with a press-contact connection apparatus according to an aspect of the invention will be described in detail with reference to accompanying drawings. Note that the present invention is not limited only to the exemplary embodiments as mentioned below.

### First Embodiment

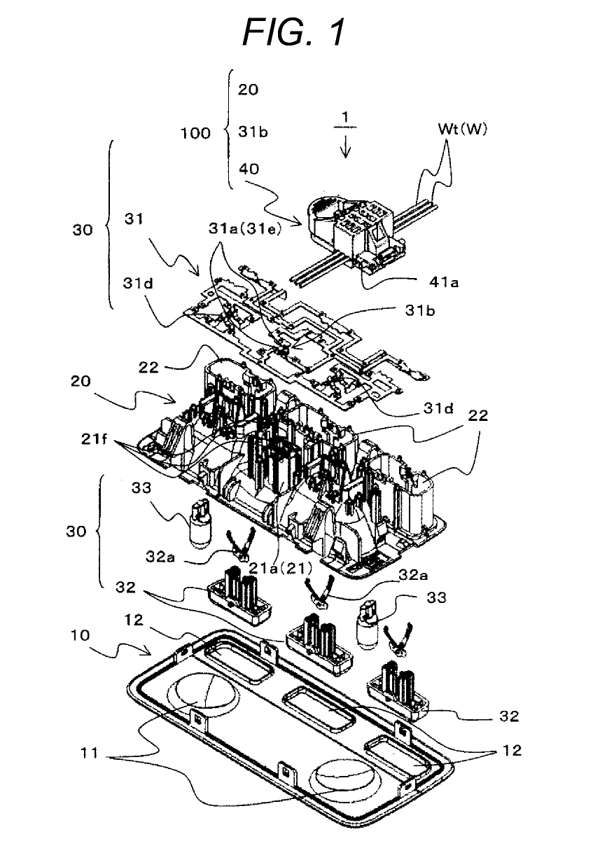

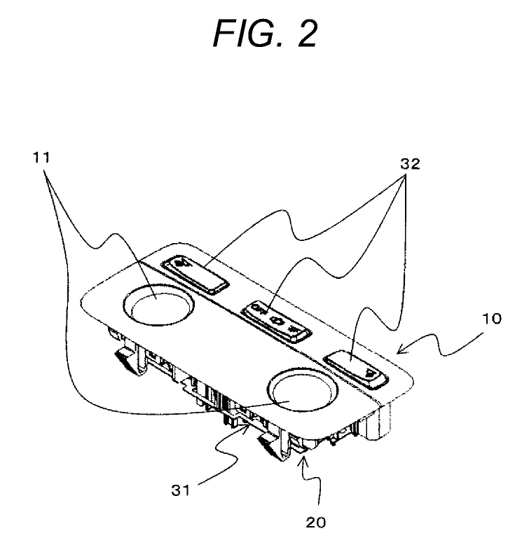

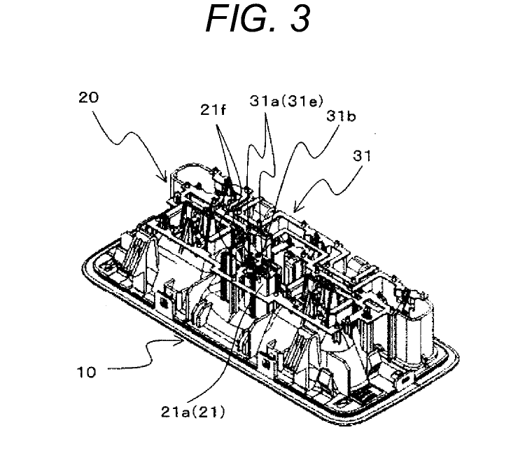

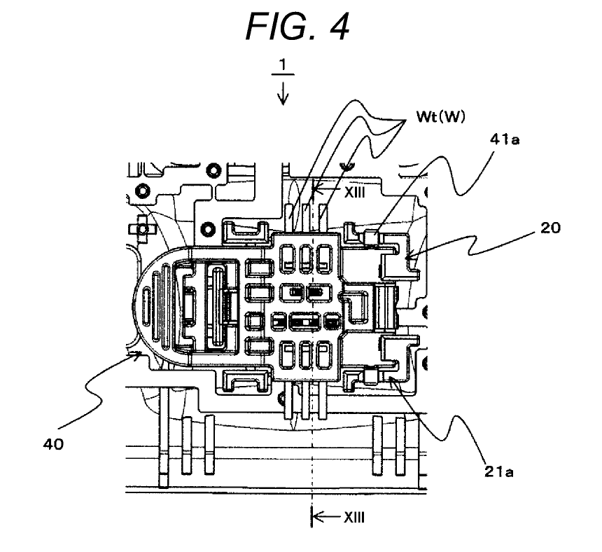

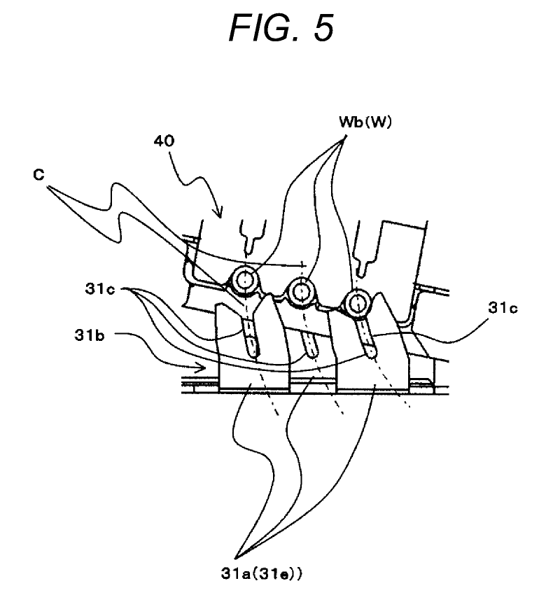

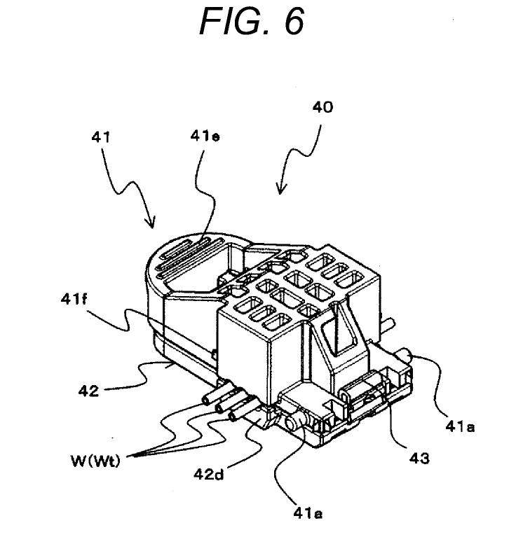

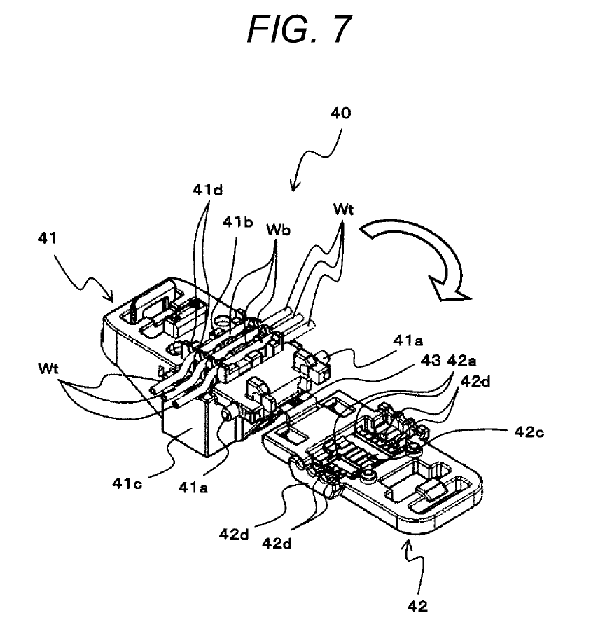

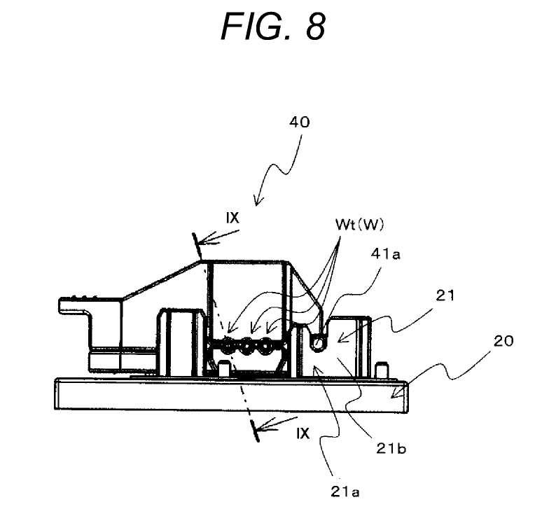

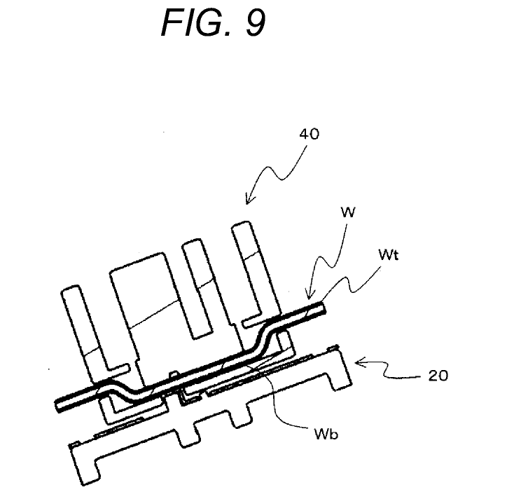

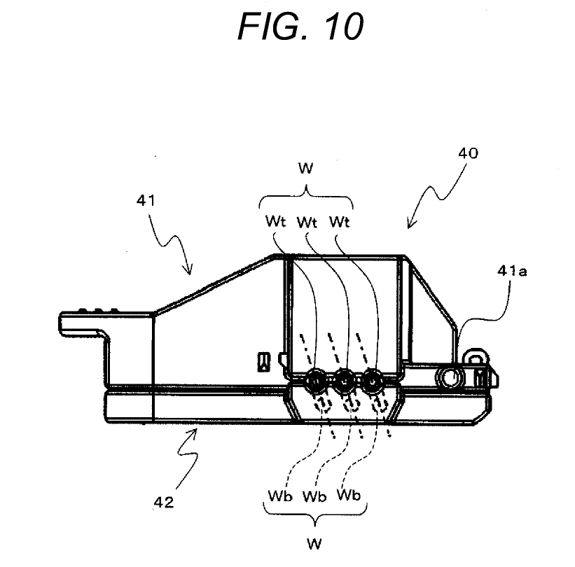

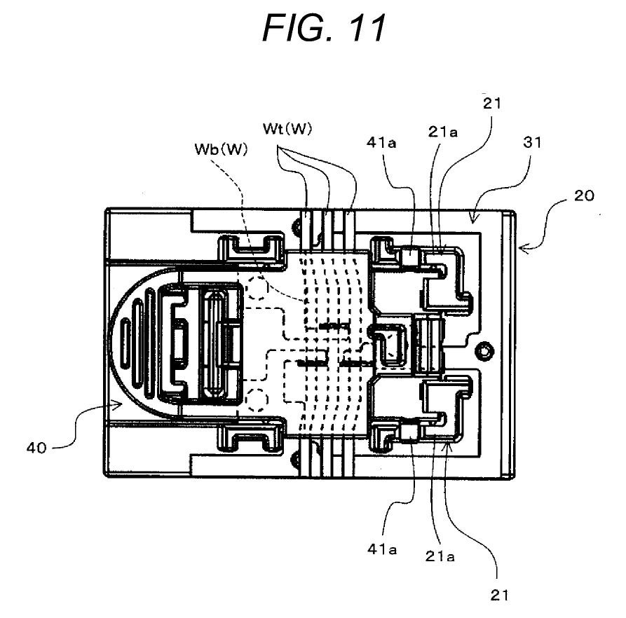

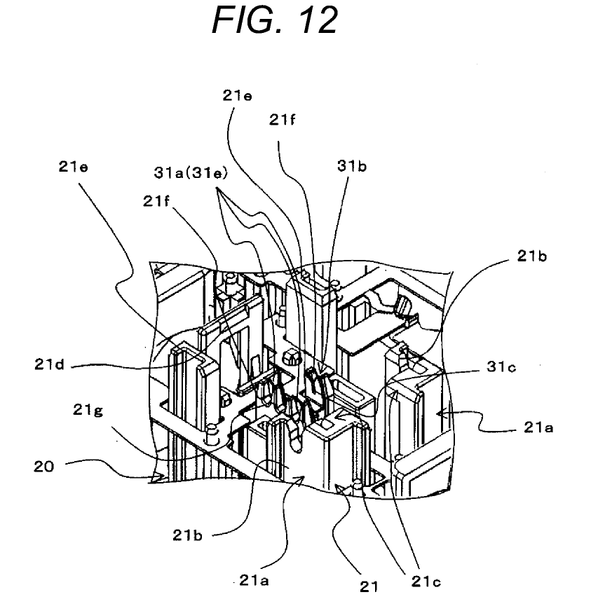

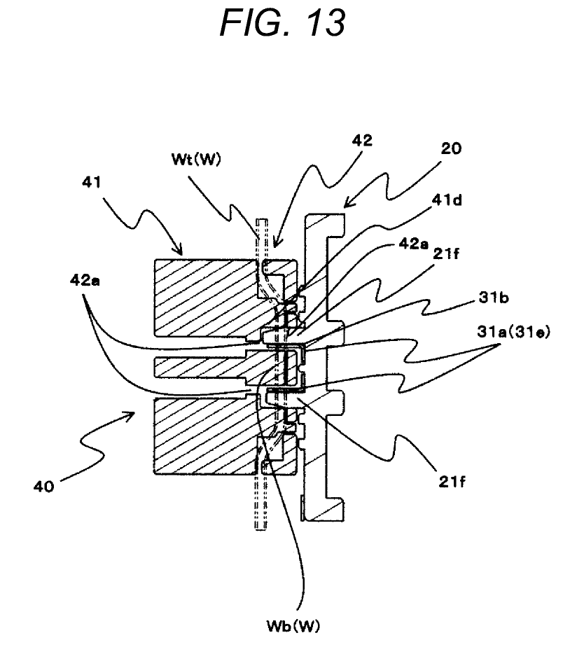

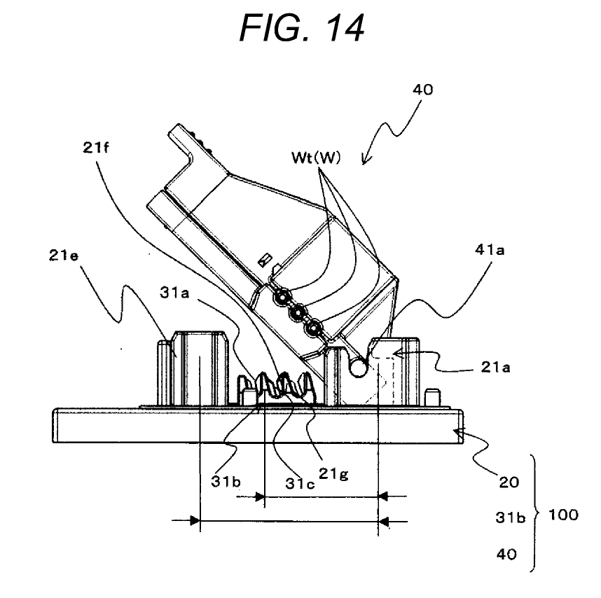

FIG. 1 is an exploded perspective view of an illumination apparatus 1 provided with a press-contact connection apparatus according to a first embodiment of the invention. FIG. 2 is a perspective view of the illumination apparatus 1 shown in FIG. 1. FIG. 3 is a perspective view showing a state before an electric wire holder 40 is attached to the illumination apparatus 1 shown in FIG. 1. FIG. 4 is a plan view in a periphery of the electric wire holder 40 as shown in FIG. 1. FIG. 5 is a diagram for explaining a press-contact terminal 31b shown in FIG. 1. FIG. 6 is a perspective view of the electric wire holder 40 shown in FIG. 1. FIG. 7 is a perspective view showing a state where an engagement of an upper pressing portion 41 and a lower pressing portion 42 of the electric wire holder 40 is released. FIG. 8 is a side view of the electric wire holder 40 shown in FIG. 1. FIG. 9 is a cross-sectional view of the electric wire holder 40 taken from line IX-IX shown in FIG. 8. FIG. 10 is a side view of the electric wire holder 40 for explaining that the electric wires W are held so as to be bent in a U-shape. FIG. 11 is a top view of the electric wire holder 40 for explaining that the electric wires W are held so as to be bent in a U-shape. FIG. 12 is an enlarged view in a periphery of the press-contact terminal 31b as shown in FIG. 3. FIG. 13 is a cross-sectional view of the illumination apparatus 1 taken from line XIII-XIII as shown in FIG. 4. FIG. 14 is a diagram for explaining that an adjacent wall 21f shown in FIG. 1 is provided closer to a vicinity of a support 21a than anti-slip wall 21e is.

The illumination apparatus 1 is disposed, for example, on a ceiling of a vehicle, and illuminates inside the vehicle. In the illumination apparatus 1, a plurality of electric wires W are press-contacted with press-contact terminals 31b. Thus, power supply from the plurality of electric wires W is enabled. The illumination apparatus 1 includes a lens 10, a housing 20 and an illumination-function part 30 as shown in FIG. 1. In the first embodiment, the illumination apparatus 1 includes three electric wires W.

First, the lens 10 will be described.

The lens 10 has a rectangular outer shape. Light-collecting portions 11 are provided in right and left positions close to the outside. Three operator reception holes 12 are formed in the lens 10.

Next, the illumination-function part 30 will be described.

As shown in FIG. 1, the illumination-function part 30 includes a bus bar 31, switch operating parts 32, valves 33 and the electric wire holder 40 which holds the plurality of electric wires W.

The bus bar 31 includes a power-feed terminal 31d and a press-contact terminal 31b provided with three press-contact blades 31a to which the three electric wires W are to be connected. As shown in FIG. 5, in each of the press-contact blade 31a, a groove 31c is formed in a shape along a circle around the rotational shaft 41a of the electric wire holder 40. Two of the three press-contact blades 31a are arranged side by side in a direction perpendicular to their thickness direction, and remaining one of the three press-contact blades 31a is arranged with a clearance in its thickness direction with respect to the two press-contact blades 31a. That is to say, the press-contact terminal 31b includes a press-contact blade group 31e in which the press-contact blades 31a are arranged with a clearance in a thickness direction of the press-contact blade 31a.

In the first embodiment, although it is exemplified that the number of electric wires W is three, the number of electric wires W is not limited to three. Further, the number of press-contact blades is also not limited, and it is provided in accordance with the number of electric wires W.

The switch operating part 32 is an operating part for switching an operation state between a light-on and a light-off of the valve 33. The switch operating part 32 is received within the housing 20, as shown in FIG. 1. The switch operating part 32 enables an electric conduction to the valve 33 by contact with the power-feed terminal 31d via a contact 32a.

The electric wire holder 40 holds the plurality of electric wires. The plurality of electric wires W are press-contacted with the press-contact terminals 31b by pressing the plurality of electric wires W held by the electric wire holder 40 onto the press-contact terminals 31b. In the electric wire holder 40, as shown in FIG. 6 and FIG. 7, an upper pressing portion 41 is coupled to a lower pressing portion 42 via a bendable coupling portion 43. The electric wire holder 40 holds the plurality of electric wires W so as to extend them in an axial direction of a rotational shaft 41a by bending the coupling portion 43 and sandwiching the plurality of electric wires W between the upper pressing portion 41 and the lower pressing portion 42.

The upper pressing portion 41 includes a finger-contact portion 41e, the rotational shaft 41a and a pair of anti-slip ribs 41f, as shown in FIG. 6. The rotational shaft 41a has a cylindrical shape, and is disposed in the vicinity of an end of the upper pressing portion 41 near the coupling portion 43. The finger-contact portion 41e is provided at the other end when the side of the coupling portion 43 is considered as one end. The finger-contact portion 41e is a portion for applying a pressure when the plurality of electric wires W held by the electric wire holder 40 is pressed onto the press-contact terminals 31b.

Each of the pair of anti-slip ribs 41f contacts each anti-slip wall 21e, which is described later, so that the electric wire holder 40 is held by the housing 20 without slipping. Each anti-slip rib 41f projects from an outer surface of each side wall of the upper pressing portion 41, and contacts each anti-slip wall 21e when the electric wire holder 40 is attached to the housing 20.

Further, as shown in FIG. 7, the upper pressing portion 41 holds a part of each electric wire W so as to be bent in a U-shape. The upper pressing portion 41 includes bottom guide portions 41b and upper guide portions 41c. The bottom guide portion 41b holds a bottom portion Wb forming a bottom of the electric wire which is bent in the U-shape. The upper guide portion 41c guides an upper extending portion Wt which is bent and extends from an upper end of the U-shape, and leads the upper extending portion Wt outside the upper pressing portion 41. The bottom guide portion 41b includes a partition step portion 41d provided to project from a surface on which the upper guide portion 41c is disposed. The partition step portion 41d bends a part of each of the electric wire W in the U-shape by providing a step from the bottom guide portion 41c.

The bottom guide portion 41b and the upper guide portion 41c holds the electric wire W so as to shift a shaft center of the electric wire extending in the axial direction of the rotational shaft 41a toward the rotational shaft 41a. Specifically, the bottom portion Wb held by the bottom guide portion 41b is arranged closer to the rotational shaft 41a than the upper extending portion Wt held by the upper guide portion 41c is.

The lower pressing portion 42 includes press-contact through portions 42a, penetration portions 42b, bottom guide portions 42c and upper guide portions 42d.

The press-contact through portion 42a is a through hole through which the press-contact blade 31a and an adjacent wall 21f, which is described later, are passed.

The penetration portion 42b is a hole through which a projection of the partition step portion 41d is penetrated. The bottom guide portions 42c are disposed in positions corresponding to the bottom guide portions 41b of the upper pressing portion 41, and guide the bottom portions Wb of the electric wires W bent in the U-shape, respectively. The upper guide portions 42d are disposed in positions corresponding to the upper guide portions 41c of the upper pressing portion 41, and guide the upper extending portions Wt of the electric wires W to lead them outside the lower pressing portion 42.

As shown in FIG. 8 through FIG. 11, the electric wire holder 40 as configured in this way bends a part of each electric wire W of the plurality of electric wires W in a U-shape. Further, the electric wire holder 40 arranges each of the electric wire W so that the bottom portion Wb constituting the bottom of the electric wire W bent in the U-shape is disposed closer to the rotational shaft 41a than the upper extending portion Wt bent and extending from the upper end of the U-shape.

Next, the housing 20 will be described.

The housing 20 as a base part is attached to the lens 10 with the illumination-function part 30 incorporated into the housing 20. The housing 20 includes a holder-receiver 21 for receiving the electric wire holder 40. The holder-receiver 21 includes supports 21a, locking parts 21d, a pair of anti-slip walls 21e, and adjacent walls 21f, as shown in FIG. 12.

The support 21a supports a rotational shaft 41a included in the electric wire holder 40 rotatably and serves as a fulcrum. The support 21a includes a bearing wall 21b which supports the rotational shaft 41a and a projection wall 21c which serves as a fulcrum. The projection wall 21c is a wall which projects towards the attachment side of the electric wire holder 40.

The locking part 21d contacts the electric wire holder 40 which is rotatably supported by the support 21a so that that electric wire holder 40 is fixed to the housing 20.

Each of the pair of anti-slip walls 21e contacts each anti-slip rib 41f so that the electric wire holder 40 is held by the housing 20 without slipping. The pair of anti-slip walls 21e are oppositely disposed so as to sandwich the outer surfaces of the both side walls of the electric wire holder 40 therebetween.

As shown in FIG. 12, the adjacent wall 21f is disposed adjacently to each press-contact blade 31a in the thickness direction of the press-contact blade 31a. A groove part 21g is formed in correspondence to a shape of the groove 31c of the press-contact blade 31a to enable the press-contact by the press-contact blade 31a. The adjacent wall 21f is a wall on which the electric wire holder 40 slides when it is rotated.

More specifically, when opposing surfaces of the press-contacts blades 31a which are arranged with a clearance in their thickness direction are assumed as an inner surface, the adjacent wall 21f is disposed adjacently to an outer surface of each of the contact blades 31a.

Further, each groove part 21g is formed larger in comparison with the shape of the groove 31c of the press-contact blade 31a so that the adjacent wall 21f does not interfere with the press-contact by the press-contact blade 31a.

The adjacent wall 21f contacts the upper pressing portion 41 and the lower pressing portion 42 of the electric wire holder 40, as shown in FIG. 13, when the adjacent wall 21f is inserted through the press-contact through portion 42a. More specifically, the adjacent wall 21f contacts a wall surface of the press-contact through portion 42a of the lower pressing portion 42, and contacts a wall surface of the partition step portion 41d of the upper pressing portion 42.

In this way, the adjacent wall 21f protects a surface of the press-contact blade 31a, and also prevents the electric wire holder 40 from being slipped in the thickness direction of the press-contact blade 31a.

Moreover, since the adjacent walls 21f adjacently disposed to the press-contact blade group 31e in which the press-contact blades 31a are disposed with a clearance in the thickness direction of the press-contact blades 31a are slid on the electric wire holder 40, the adjacent walls 21f which are disposed with a clearance in the thickness direction of the press-contact blades 31a contact the electric wire holder. Thus, the prevention of the electric wire holder 40 from being slipped in the thickness direction of the press-contact blade 31a can be more enhanced.

Still further, as shown in FIG. 14, since the adjacent walls 21f are disposed closer to the vicinity of the supports 21a than each of the anti-slip walls 21e, where an area which the adjacent wall 21f contacts the electric wire is the same as that of the anti-slip wall 21e, it becomes possible to reduce a load applied to the adjacent wall when the electric wire holder 40 is to be held by the housing 20 more than the that applied to the anti-slip wall 21e by the action of the principle of leverage.

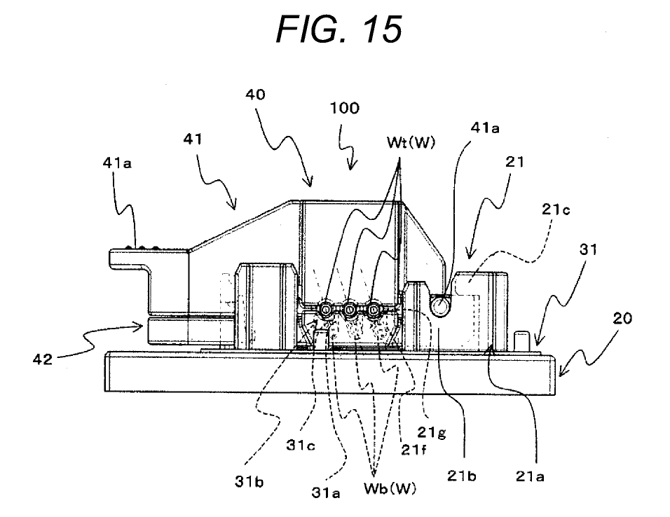

Here, the press-contact connection apparatus 100 will be described with reference to FIG. 15. FIG. 15 is a side view showing the press-contact connection apparatus 100 according to the first embodiment of the invention. The press-contact connection apparatus 100 includes the electric wire holder 40, the housing 20 as a base part and the press-contact terminals 31b fixed to the housing 20. The press-contact connection apparatus 100 press-contacts the plurality of electric wires W onto the press-contact terminals 31b by pressing the plurality of electric wires W held by the electric wire holder 40 onto the respective grooves of the press-contact terminals 31b.

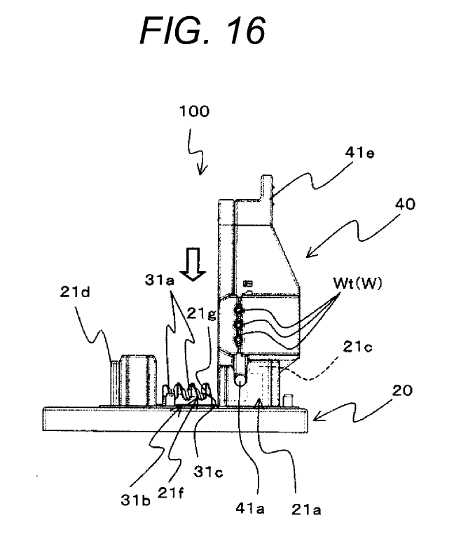

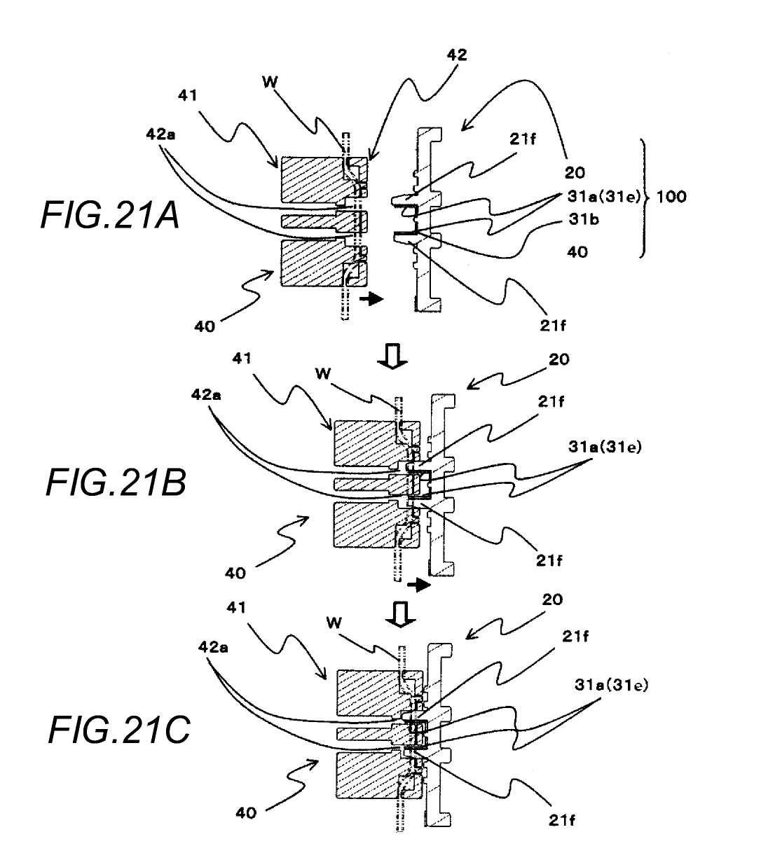

Next, a procedure of press-contacting the plurality of electric wires W onto the press-contact terminals 31b by the press-contact connection apparatus 100 is explained with reference to FIG. 16 through FIG. 21C. FIG. 16 through FIG. 20 are diagrams showing the procedure of press-contacting the plurality of electric wires W onto the press-contact terminals 31b by the press-contact connection apparatus 100. FIGS. 21A to 21C are diagrams for explaining that the electric wire W comes close to the press-contact blade 31a in accordance with rotation of the electric wire holder 40.

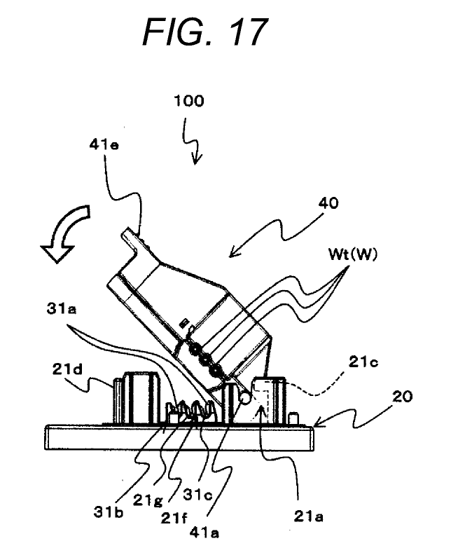

First, the rotational shaft 41a of the electric wire holder 40 is attached to the supports 21a (see FIG. 16). Then, the electric wire holder 40 is rotated around the rotational shaft 41a (see FIG. 17). At this time, the electric wire holder 40 is rotated, and also the plurality of electric wires W come close to each of the press-contact blades 31a (see FIG. 21A).

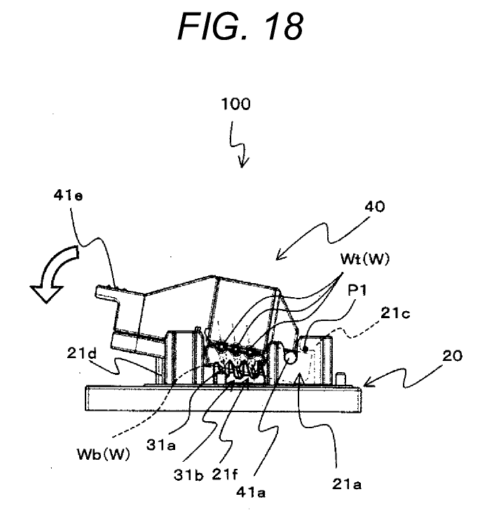

After that, the electric wire W contacts the press-contact blade 31a in accordance with the rotation of the electric wire holder 40 (see FIG. 18). In this case, the bottom portion Wb of the electric wire W bent in a U-shape contacts the press-contact blade 31a. That is, the portion of the electric wire W closer to the rotational shaft 41a is press-contacted. Further, when the electric wire W contacts the press-contact blade 31a, the electric wire holder 40 contacts the projection wall 21c by the reaction force. In this way, the projection wall 21c serves as a fulcrum P1 in the principle of leverage, and the electric wire W can be press-contacted while bringing the electric wire W close to the fulcrum P1.

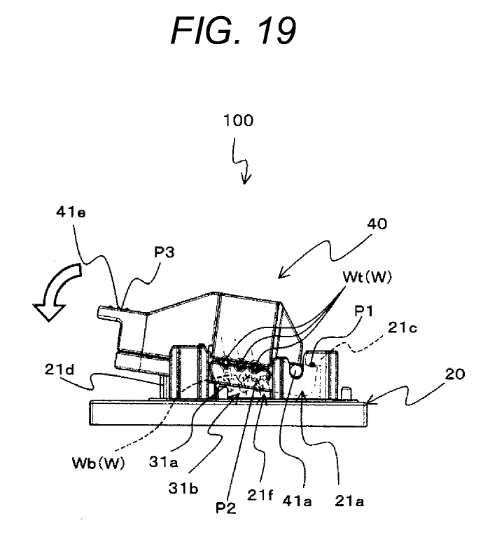

Then, as the electric wire holder 40 is further rotated, the electric wires W are press-contacted onto the respective press-contact terminals 31b (see FIG. 19). At this time, the bottom portion Wb of the electric wires W are press-contacted while the projection wall 21c serves as the fulcrum P1, the press-contacted electric wires W serve as a point of action P2, and the finger-contact portion 41e serves as a point of effort P3. Further, the adjacent wall 21f is slid on the electric wire holder 40 when the electric wire holder 40 is rotated (see FIG. 21B).

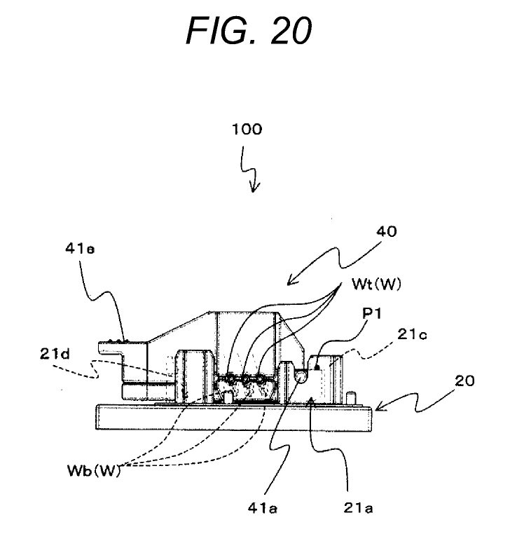

Then, as the electric wire holder 40 is further rotated, the electric wire holder 40 is fixed to the housing 20 by the locking portion 21c, and the press-contact is completed (see FIG. 20). At this time, the adjacent wall 21f is being contact with the electric wire holder 40, and the electric wire holder 40 is held by the housing 20 (see FIG. 21C).

According to the press-contact connection apparatus 100 of the first embodiment, since the plurality of electric wires W are held while bending a part of each electric wire W in a U-shape, the connection state between the electric wires W and the press-contact terminals 31b is surely maintained. Further, since the bottom portion Wb in the U-shape of the electric wire W is arranged closer to the support 21a than the upper extending portion Wt bent and extending from the upper end of the U-shape is, the electric wire W can be press-contacted while bringing the electric wire W close to the fulcrum P. As a consequence, a load to be applied during the press-contact can be minimized.

According to the press-contact connection apparatus 100 of the first embodiment, since the groove 31c of the contact blade 31a is formed along the extending direction of the electric wire W which is inserted to be press-contacted, the load applied to the press-contact blade 31a can be suppressed. Consequently, the deformation of the press-contact terminal 31b can be prevented.

According to the press-contact connection apparatus 100 of the first embodiment, the housing 20 includes the adjacent wall 21f which is disposed adjacently to each press-contact blade 31a in the thickness direction of the press-contact blade 31a, in which the groove part 21g is formed in correspondence to the shape of the groove 31c of the press-contact blade 31a to enable the press-contact by the press-contact blade 31, and which is a wall on which the electric wire holder 40 slides when it is rotated. Accordingly, it is possible to protect a surface of the press-contact blade 31a, and also prevent the electric wire holder 40 from being slipped in the thickness direction of the press-contact blade 31a.

According to the press-contact connection apparatus 100 of the first embodiment, the adjacent wall 21f having the function of slipping prevention is disposed closer to the connection part of the electric wire W and the press-contact blade 31a. Accordingly, the function of slipping prevention at the connection part is quite well, and consequently, connection reliability can be enhanced.

According to the press-contact connection apparatus 100 of the first embodiment, the adjacent wall 21f has the function of preventing the electric wire holder 40 from being slipped in the thickness direction of the press-contact blade 31a. Accordingly, it becomes unnecessary to provide another structure of the anti-slip rib 41f and the anti-slip wall 21e which have the similar function. Consequently, the structure of the apparatus can be simplified.

According to the press-contact connection apparatus 100 of the first embodiment, the press-contact terminal 31b includes the press-contact blade group 31e in which the press-contact blades 31a are arranged with a clearance in the thickness direction of the press-contact blade 31a, and the adjacent walls 21f disposed adjacently to the press-contact blade group 31e are slid on the electric wire holder 40. That is, the adjacent walls 21 which are disposed with a clearance in the thickness direction of the press-contact blades 31a contact the electric wire holder 40. Thus, the prevention of the electric wire holder 40 from being slipped in the thickness direction of the press-contact blade 31a can be more enhanced.

### Second Embodiment

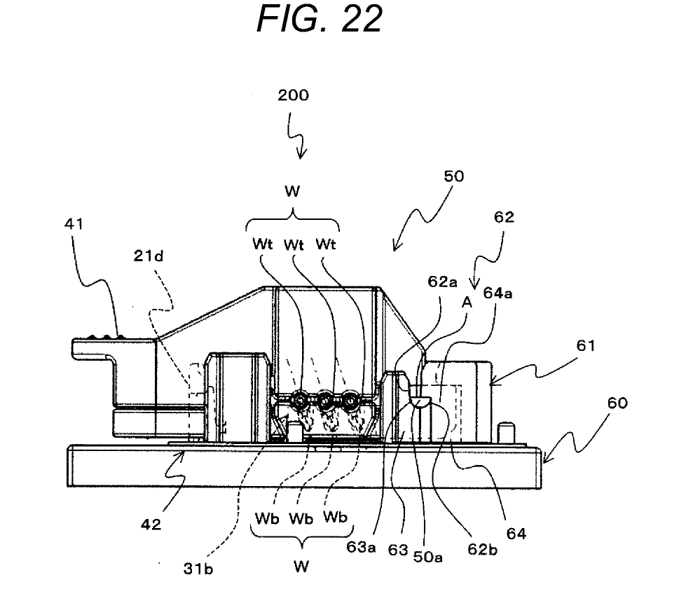

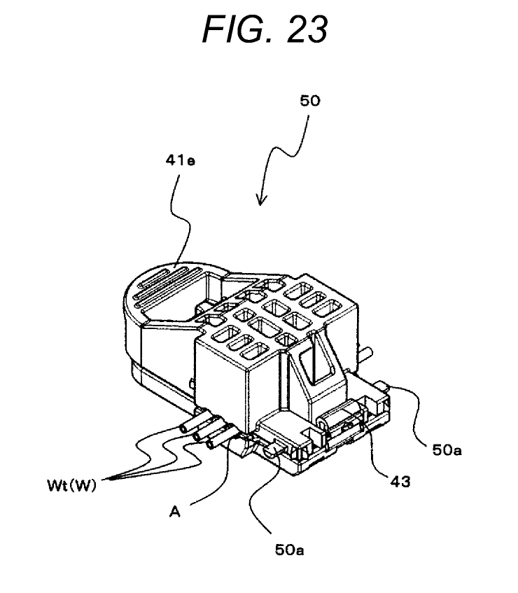

Next, a second embodiment of the invention is explained. FIG. 22 is a side view showing a press-contact connection apparatus 200 according to the second embodiment of the invention. FIG. 23 is a perspective view of an electric wire holder 50 shown in FIG. 22. In the first embodiment described above, the cylindrical shape is exemplified as the rotational shaft 41a of the electric wire holder 40. In the press-contact connection apparatus 200 of the second embodiment, the electric wire holder 50 includes a rotational shaft 50a having a semi-circular columnar shape, as shown in FIG. 22 and FIG. 23. The housing 60 includes a support 61 instead of the support 21a explained in the first embodiment. Other configuration in the second embodiment is the same as in the first embodiment, and the same symbols or numbers are assigned to the same parts.

As shown in FIG. 22, the support 61 includes a bearing wall portion 62 which supports the rotational shaft 50a. The bearing wall portion 62 includes a first wall 63 and a second wall 64. The first wall 63 includes a curved surface shape portion 63a formed substantially equal to a curved surface shape of the rotational shaft 50a. The electric wire holder 50 is rotated by causing the curved portion of the rotational shaft 50a to contact the curved surface shape portion 63a.

The second wall 64 includes a projection wall 64a. The projection wall 64a is projected from an upper wall surface of the wall toward a side of supporting the rotational shaft 50a, and serves as a fulcrum. In the bearing wall portion 62, a slit 62a is formed between the first wall 63 and the second wall 64. The slit width of the slit 62a is substantially equal to the radius of the rotational shaft 50a. In the bearing wall portion 62, an upper portion of the bearing wall portion 62 opens by the slit 62a. The upper opening caused by the slit 62a serves as an insertion port of the rotational shaft 50a when the electric wire holder 50 is to be attached to the support 61.

In the bearing wall portion 62, an enlarged slit 62b is also formed below the projection wall 64a. The enlarged slit 62b is formed by enlarging a back of the slit 62a and continuous from the slit 62a. The enlarged slit 62b can support the rotational shaft 50a while directing a normal line to a plane surface A of the rotational shaft 50a upwardly. That is, when the electric wire holder 50 is to be attached to the support 61, the rotation of the rotational shaft 50a which has been inserted into the slit 62a is regulated in a state where the normal line to the plane surface A is directed in a horizontal direction. And then, the rotational shaft 50a can be rotated until the normal line to the plane surface A of the rotational shaft 50a is directed upwardly, that is, contacts the projection wall 64a in the enlarged slit 62b.

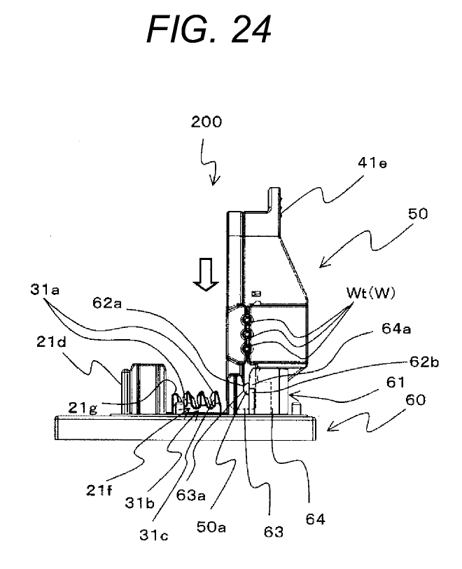

Here, a procedure of press-contacting the plurality of electric wires W onto the press-contact terminals 31b by the press-contact connection apparatus 200 is explained with reference to FIG. 24 through FIG. 28 and FIG. 21A to 21C. FIG. 24 through FIG. 28 are diagrams showing the procedure of press-contacting the plurality of electric wires W onto the press-contact terminals 31b by the press-contact connection apparatus 200. In the explanation of FIGS. 21A to 21C, it is assumed that the electric wire holder 40 is replaced with the electric wire holder 50, and the housing 20 is replaced with the housing 60, and it is described that the electric wire W comes close to the press-contact blade 31a in accordance with rotation of the electric wire holder 50.

First, the rotational shaft 50a of the electric wire holder 50 is attached to the support 61 (see FIG. 24). When the rotational shaft 50a is inserted from the slit 62a, and is to be attached to the support 61, the slit 62a having a slit width which is substantially equal to the radius of the rotational shaft 50a having the semi-circular columnar shape guides the rotational shaft 50a.

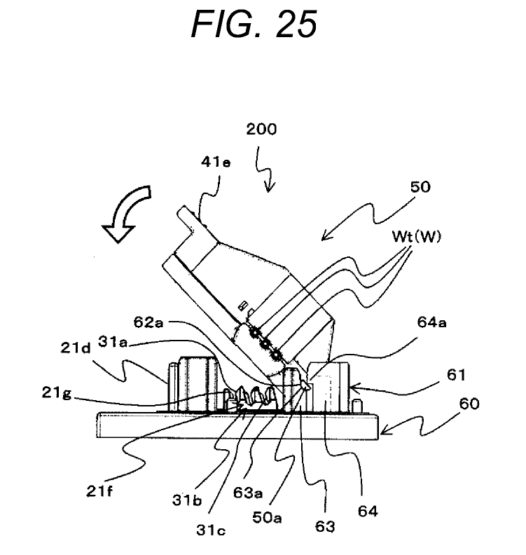

Then, the electric wire holder 50 is rotated around the rotational shaft 50a (see FIG. 25). At this time, the electric wire holder 50 is rotated, and each of the plurality of electric wires W comes close to the respective press-contact blades 31a.

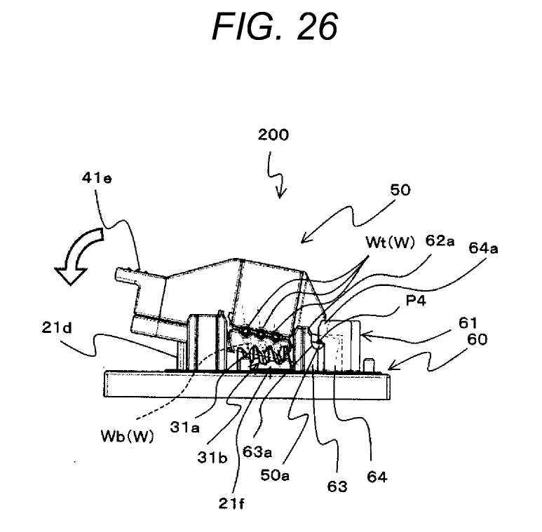

Then, when the electric wires W contact the press-contact blades 31a in accordance with the rotation of the electric wire holder 50, the plane surface A of the rotational shaft 50a contacts the projection wall 64a by the reaction force of a force for cutting the electric wires W (see FIG. 26). In this way, the projection wall 64a serves as a fulcrum P4 in the principle of leverage, and the electric wire W can be press-contacted while bringing the electric wire W close to the fulcrum P4.

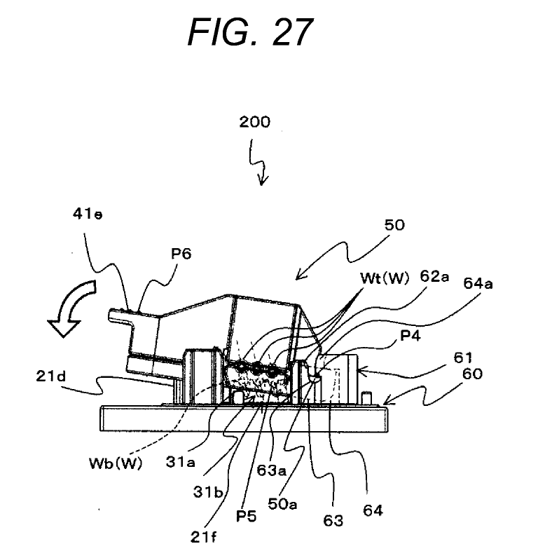

Then, as the electric wire holder 50 is further rotated, the electric wire W is press-contacted. At this time, the bottom portion Wb of the electric wires W are press-contacted while the projection wall 64a serves as the fulcrum P4, the press-contacted electric wires W serve as a point of action P5, and the finger-contact portion 41e serves as a point of effort P6 (see FIG. 27). Further, the adjacent wall 21f is slid on the electric wire holder 50 when the electric wire holder 50 is rotated.

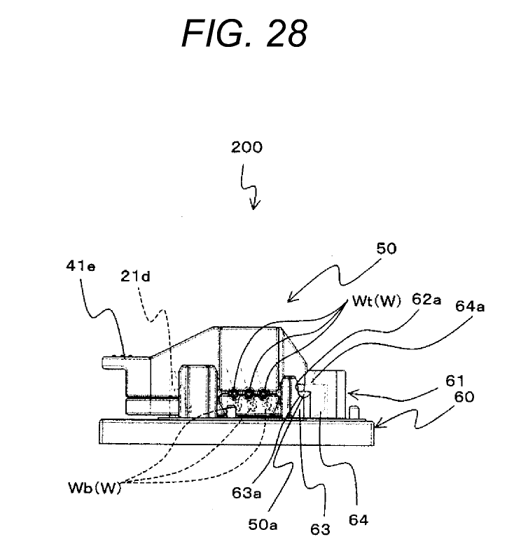

Then, the electric wire holder 50 is fixed to the housing 60 by the locking portion 21c, and the press-contact is completed (see FIG. 28). At this time, the adjacent wall 21f is being contact with the electric wire holder 50, and the electric wire holder 50 is held by the housing 60 (see FIG. 21C).

According to the press-contact connection apparatus 200 of the second embodiment, it has the same advantage as the press-contact connection apparatus 100 of the first embodiment. Moreover, when the rotational shaft 50a is inserted from the slit 62a, and is to be attached to the support 61, the slit 62a having a slit width which is substantially equal to the radius of the rotational shaft 50a having the semi-circular columnar shape guides the rotational shaft 50a. Thus, the assembly work of the electric wire holder 50 is facilitated.

According to the press-contact connection apparatus 200 of the second embodiment, the fulcrum P4 becomes closer to the point of action P5 as compared with the first embodiment. Thus, the load applied during the press-contact can be minimized as compared with the first embodiment.

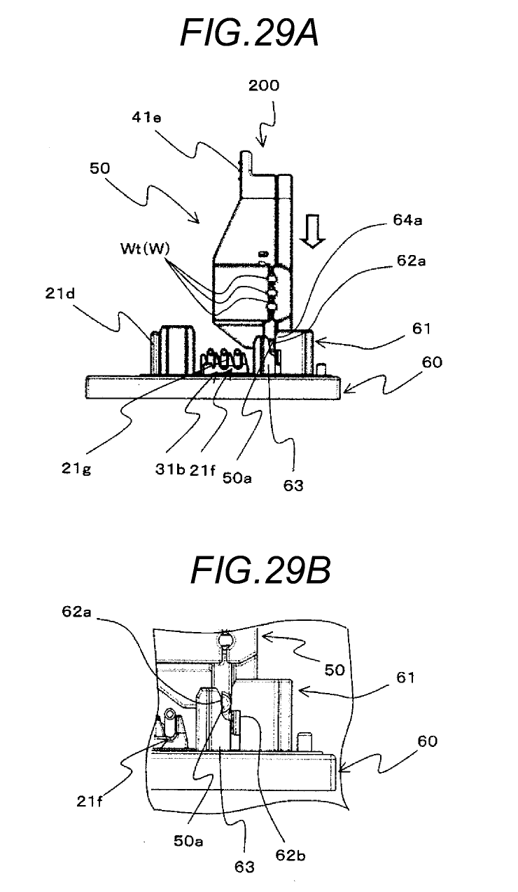

According to the press-contact connection apparatus 200 of the second embodiment, as shown in FIGS. 29A and 29B, even if the user mistakes the attachment direction of the electric wire holder 50 to the support 61, the rotation of the electric wire holder 50 is regulated by the slit 62a. Thus, the error in the attachment can be prevented.

In the first and second embodiments, it has been described that, when opposing surfaces of the press-contacts blades 31a which are arranged with a clearance in their thickness direction are assumed as an inner surface, the adjacent wall 21f is disposed adjacently to an outer surface of each of the contact blades 31a, but the invention is not limited thereto. That is, the requirement is that the adjacent wall 21f is a wall which is disposed adjacently to the press-contact blade 31a in the thickness direction of the press-contact blade 31a, and contacts the electric wire holder 40 or 50. For example, when opposing surfaces of the press-contacts blades 31a which are arranged with a clearance in their thickness direction are assumed as an inner surface, the adjacent wall 21f may be disposed adjacently to the inner surface of each of the contact blades 31a

What is claimed is:

1. A press-contact connection apparatus, comprising:
a base part;
press-contact terminals which are fixed to the base part; and
an electric wire holder which holds a plurality of electric wires to be press-contacted with the respective press-contact terminals, wherein
the base part includes a support which supports the electric wire holder rotatably and serves as a fulcrum of a rotation of the electric wire,
the electric wire holder includes a rotational shaft which is provided in one end portion of the electric wire holder and supported by the support of the base part, and
the electric wire holder holds the plurality of electric wires to be extended in an axial direction of the rotational shaft, and bends a part of each electric wire in a U-shape so that a bottom portion of the U-shape is arranged closer to the support than a portion bent and extending from an upper end of the U-shape is arranged.

2. The press-contact connection apparatus according to claim 1, wherein
the rotational shaft has a semi-circular columnar shape, and
the support includes a slit which is open to an upper end of the support and through which the rotational shaft is inserted, the width of the slit being substantially equal to the radius of the rotational shaft.

3. The press-contact connection apparatus according to claim 2, wherein
the support further includes an enlarged slit which is formed by enlarging a back of the slit and is continuous from the slit so as to rotate the rotational shaft in the enlarged slit.

4. The press-contact connection apparatus according to claim 1, wherein
the press-contact terminal includes a press-contact blade, and the press-contact blade is provided with a groove being formed in a shape along a circle around the rotating shaft.

5. The press-contact connection apparatus according to claim 4, wherein
the base part includes an adjacent wall which is disposed adjacently to the press-contact blade in the thickness direction of the press-contact blade, in which a groove part is formed in correspondence with a shape of the groove of the press-contact blade to enable the press-contact by the press-contact blade, and which is a wall on which the electric wire holder slides when the electric wire holder is rotated.

6. The press-contact connection apparatus according to claim 5, wherein
the press-contact blade is provided in plural, and the press-contact terminal includes a press-contact blade group in which the press-contact blades are disposed with a clearance in the thickness direction of the press-contact blades.

7. An illumination apparatus provided with the press-contact connection apparatus according to claim 1, wherein
the illumination apparatus is capable of an illumination function by supplying a power from the plurality of electric wires which are press-contacted with the press-contact terminals of the press-contact connection apparatus.
